(19) United States
(12) Patent Application Publication
(10) Pub. No.: US 2006/0010175 A1
(43) Pub. Date: Jan. 12, 2006

(54) Apparatus, system, and method for automated conversion of content having multiple representation versions

(75) Inventor: Michael Yiupun Kwong, Stanford, CA (US)

Correspondence Address: KUNZLER & ASSOCIATES, 8 EAST BROADWAY, SUITE 600, SALT LAKE CITY, UT, 84111, US

(73) Assignee: INTERNATIONAL BUSINESS MACHINES CORPORATION, Armonk, NY (US)

(21) Appl. No.: 10/870,273

(22) Filed: Jun. 17, 2004

(51) Int. Cl. G06F 17/30

(52) U.S. Cl. 707/203; 717/170

(57) ABSTRACT

An apparatus, system, and method for automated conversion of content reduces the development and support burden associated with multiple content representation versions such as those associated with various releases of a software program. In one embodiment, a version identification module determines a source version identifier for specified content, a sequence determination module receives the source version identifier along with a target version identifier and determines a minimum length conversion sequence. Furthermore, a conversion control module invokes one or more content converters corresponding to the conversion sequence and provides the specified content in the target representation. The ability to cascade multiple content converters into a composite converter increases the permutation of content representations that may be supported with a small number of converters.

### BACKGROUND OF THE INVENTION

1. Field of the Invention

The invention relates to managing persistent content in data processing environments. Specifically, the invention relates to apparatus, systems, and methods for automated conversion of content having multiple representation versions to a target representation version.

2. Description of the Related Art

Software programs and associated file formats and data encodings are often improved with each revision. Generally, with each major release of a software program, content converters are developed to import previously created content stored in older formats and encodings to the newest representation. In addition, the content converters may add additional data structures such as tables or fields as well as additional functional modules to the previously created content. For purposes of compatibility with users of older versions of software, converters may also be developed to export the newest content format and encoding to older representations.

Due to the complexity and cost of developing content converters and the large number of content types that may be supported, many software programs restrict the number of file formats and encodings that are actively supported. For example, a particular release of a software program may support only two or three versions of a particular file format. In addition, due to the large number of possible permutations involved, supported conversions are typically restricted to those involving the newest format or representation.

Users of software programs may have large stores of accumulated content such as text, data, metadata, and code stored in a variety of formats and encodings. Such content may be archived and unused for substantial periods of time before a need arises to use the content. In such situations, the currently installed programs may be unable to import the content of interest thus imposing a considerable processing burden on the users or their Information Technology (IT) support staff to manually convert the old files or regenerate the desired content using currently installed tools.

FIG. 1 is a directed graph further illustrating certain issues related to supporting multiple versions of software-related content. During the life-cycle of software-based products such as applications, utilities, industrial controllers, consumer appliances, and the like, a series of releases 110 may be developed and provided to the market. Typically referred to as “versions” of the product, such releases usually involve a change in the internal arrangement of data (i.e. content) related to the software program, and often involve a corresponding change in the persistent content generated in conjunction with usage of the program such as data files containing user created content. Furthermore, these releases also can include changes to data structures to support added functionality. For example, fields may be added or deleted from newly created persistent content. Consequently, the existing persistent content should be changed to include data structures to support of the added functionality, such as new fields.

As users upgrade to a newer version of software it is often desirable to import content stored in an older format and encoding (i.e. representation) and convert 120 (i.e. migrate) such content to the newer representation. Ideally, as depicted in FIG. 1, the newest version of a software program (i.e., V6) would be capable of converting each previous representation 130 to the newest representation 140. Even more ideally, the software program would be capable of converting between any desired pair of representations such that content could be exchanged with users who have not upgraded to the newest release of the software program. In such a situation, a directed graph representing the possible conversions would be a complete graph having N·(N−1) possible conversions where N is the number of released versions. For example with seven releases of a software program, 42 such conversions could be supported, 12 of which would need to be developed for the latest release.

However, due to the burden of developing and maintaining representation converters, a more selective strategy is usually deployed as depicted in the directed graphs of FIG. 2. Instead of developing representation converters for each previous version, only selected versions 210 are supported such as the most recent versions. For example, in graph 200a, import converters 120a and export converters 120b are developed to migrate content between versions four and five and the latest version six. The other representation versions are relegated to unsupported versions 220. In graph 200a, only two import converters 120a and two export converters 120b are developed for the new release V6. Similarly in graph 200b, again only two import converters 120a are developed for the newest release V7. In certain instances, two export converters 120b may be developed for the newest release V7. In certain embodiments, conversion to previous versions may not be needed.

While a reduced support strategy such as the depicted strategy significantly reduces the development and support associated with a new release, such a strategy may be unacceptable to users of the software program. For example, certain users such as large institutional users may be reluctant to upgrade with each release due to the cost and complexity associated with such a change. Furthermore, the content representations used to store their content may be unsupported resulting in further reluctance to upgrade and lost sales opportunities for the software vendor.

What is needed is a methodology for supporting new content representations that addresses the aforementioned issues. Specifically, what is needed is an apparatus, system, and method for automated conversion of content between multiple representation versions. Beneficially, such an apparatus, system, and method would reduce the number of representation converters required to be developed with each new release or functional change of a software program.

### SUMMARY OF THE INVENTION

The various embodiments of the present invention have been developed in response to the present state of the art, and in particular, in response to the problems and needs in the art that have not yet been met by currently available content migration means and methods. Accordingly, the various embodiments have been developed to provide an apparatus, system, and method for that overcome many or all of the above-discussed shortcomings in the art.

An apparatus for automated conversion of content having multiple representation versions is presented that in one embodiment includes a version identification module that determines a source version identifier for specified content, a sequence determination module that receives the source version identifier and determines a conversion sequence, and a conversion control module that invokes one or more content converters corresponding to the conversion sequence.

In one embodiment, the sequence determination module selects a minimum length conversion sequence by analyzing the possible conversion sequences for a particular source and target version. In another embodiment, a set of manually defined conversion sequences are coded into a lookup table accessed by the sequence determination module. In another embodiment, a set of migration rules are read by the sequence determination module and applied to determine the conversion sequence to carry out. In another embodiment, the sequence determination module is an object factory that is coded to generate the conversion sequence using design pattern methods.

The content converters invoked by the conversion control module may be incremental converters that correspond to releases of a software product. Each incremental converter converts content from a particular representation version corresponding to a preceding release to a subsequent representation version that corresponds to a subsequent release. In certain embodiments, some of the converters may comprise decremental converters that convert content from a particular representation version to a previous representation version. Additionally, one or more direct converters may be included that convert between two specific (non-sequential) content representation versions.

Elements of the aforementioned apparatus and method may be included in a system for automated conversion of content. In one embodiment, the system includes a storage device configured to store content, a processing unit configured to conduct certain operations including an operation to determine a source version identifier for specified content, an operation to determine a conversion sequence capable of converting the specified content to a target version, and an operation to invoke at least one content converter corresponding to the conversion sequence. In certain embodiments, the program may be stored on a signal bearing medium in a form that is executable by a digital processing apparatus.

The various embodiments presented herein reduce the cost and complexity of supporting multiple representations of content and migrating such content to newer representations as newer versions are released. Additional features and advantages of the various embodiments presented herein will become more fully apparent from the following description and appended claims, or may be learned by the practice of embodiments of the invention as set forth hereinafter.

### BRIEF DESCRIPTION OF THE DRAWINGS

In order that the advantages of the different embodiments of the invention will be readily understood, a more particular description of the embodiments briefly described above will be rendered by reference to specific embodiments that are illustrated in the appended drawings. Understanding that these drawings depict only typical embodiments of the invention and are not therefore to be considered to be limiting of its scope, the embodiments will be described and explained with additional specificity and detail through the use of the accompanying drawings, in which:

FIG. 1 is a directed graph depicting certain issues related to supporting multiple versions software-related content;

FIG. 2 is a pair of directed graphs depicting a conventional strategy for supporting multiple versions of software-related content;

FIG. 3 is a directed graph depicting one embodiment of a presently disclosed strategy for supporting and migrating software-related content;

FIG. 4 is a directed graph depicting an alternative embodiment of a presently disclosed strategy for supporting and migrating software-related content;

FIG. 5 is a block diagram depicting one embodiment of a system and apparatus for automated conversion of software-related content;

FIG. 6 is a flow chart depicting one embodiment of a method for automated conversion of software-related content; and

FIG. 7 is a directed graph and associated table depicting example results for the method of FIG. 6.

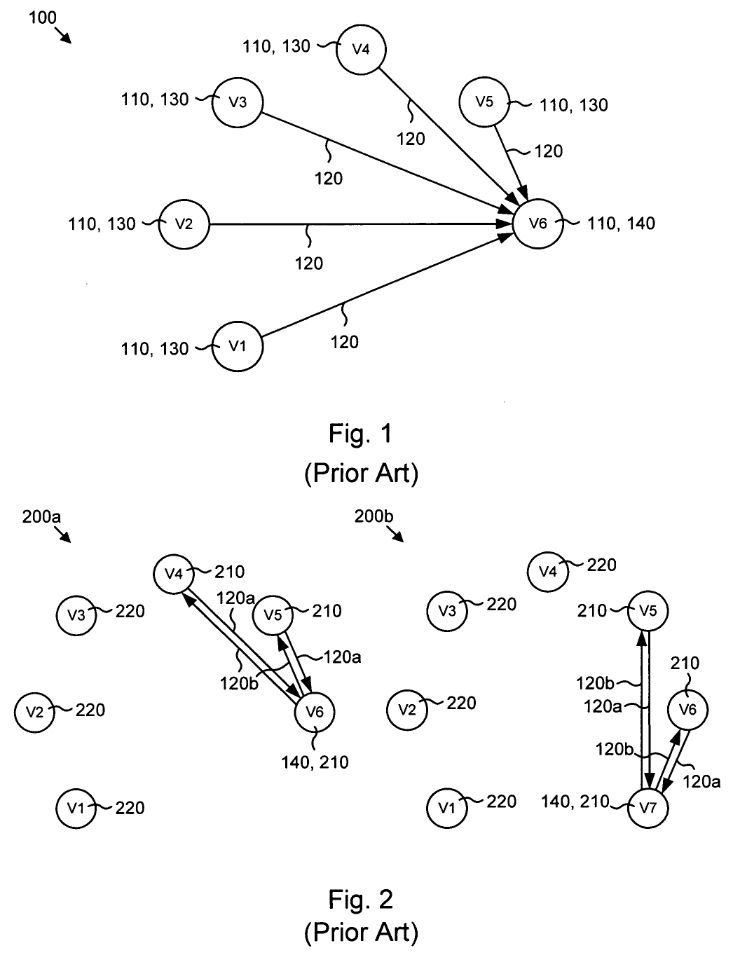

### DETAILED DESCRIPTION OF THE INVENTION

It will be readily understood that the various embodiments generally described herein and illustrated in the attached Figures, as well as the components used within such embodiments, may be arranged and designed in a wide variety of different configurations. Thus, the various embodiments presented in the Figures and associated detailed description are merely representative embodiments of the claimed invention and proper interpretation of the appended claims should not be restricted to the representative embodiments contained herein.

Furthermore, many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the embodiments of the invention can be practiced without one or more of the specific details, or with other methods, components, materials, etc. In other instances, well-known structures, materials, or operations are not shown or described in detail to avoid obscuring aspects of the various embodiments.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

The various embodiments presented herein reduce the development burden associated with a new release of a software program while enabling a software vendor to provide support to a larger number of previous versions of content storage. Specifically, a strategy and associated apparatus, system, and method for automated conversion of software-related content are presented that combines multiple conversions associated with intermediate releases of a software program or the like into a composite conversion process.

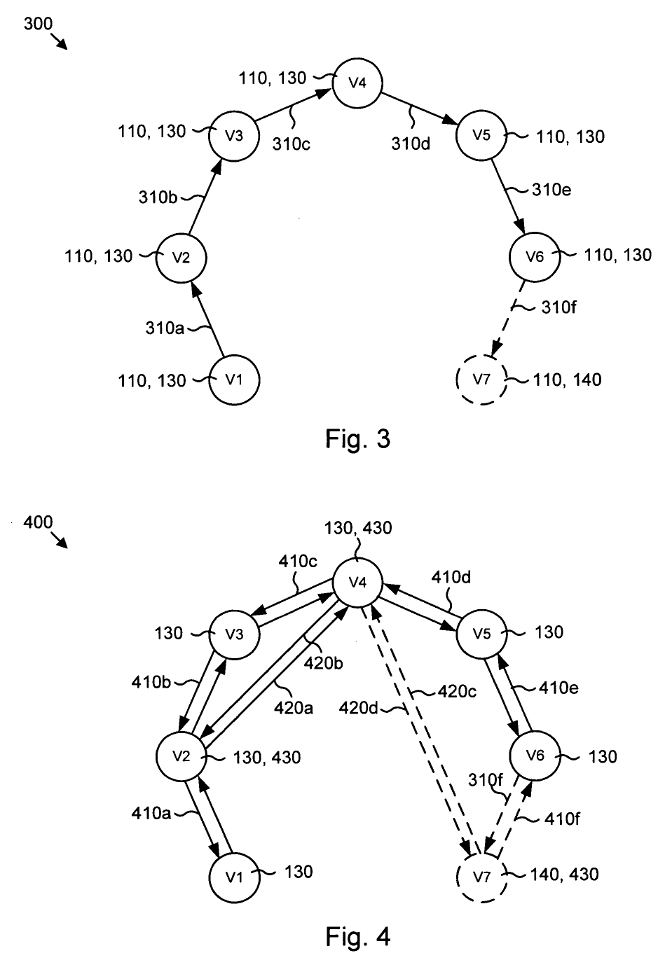

FIG. 3 is a directed graph depicting one embodiment of a strategy 300 for supporting and migrating software-related content. As depicted, the strategy 300 includes a series of incremental conversions 310 (specifically conversions 310a thru 310f) that convert each version of content representation 110 to a subsequent version including a latest version 140 which may be associated with a current release of a software program.

In contrast to the graph 200b (depicted in FIG. 2) which requires the development of multiple conversions 210 in conjunction with the introduction of version 7, the strategy 300 requires the development of only one new conversion namely the incremental conversion 310f. Furthermore, the strategy 300 provides migration support for all seven releases while the strategy 200b leaves a majority of the releases unsupported namely the four unsupported releases 220 depicted in FIG. 2.

FIG. 4 depicts an alternative embodiment of such a strategy namely a strategy 400 that also includes a series of decremental conversions 410a-f that convert each version 130 of content representation to a previous version 130. Furthermore, the strategy 400 may include select direct conversions 420 that convert content representations between specific versions such as two popular versions 430. Select direct conversions 420 may improve conversion efficiency over successive incremental conversions 310 (See FIG. 3) without significantly increasing the development and support effort associated with converting content representations. In the depicted arrangement, two direct conversions 420c,d, and one decremental conversion 410f would be developed for the latest release (i.e. version 7) in addition to one incremental conversion 310f.

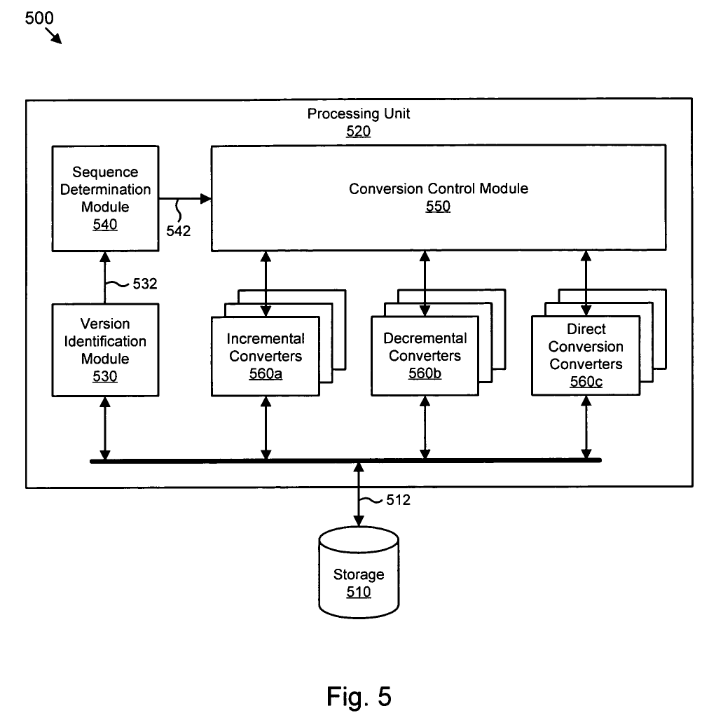

FIG. 5 is a block diagram depicting one embodiment of an automated conversion system 500. As depicted, the automated conversion system 500 includes a storage device 510 and processing unit 520 configured with a version identification module 530, a sequence determination module 540, a conversion control module 550, and a set of content converters 560 which may include incremental converters 560a, decremental converters 560b, and direct converters 560c.

The storage device 510 stores data files and the like, including persistent content associated with software programs. The processing unit 520 receives the persistent content 512 such as content specified by a user or system administrator and determines a source version for the content in addition to a conversion sequence capable of converting the content to a selected target version. The processing unit 520 may also invoke one or more content converters 560 corresponding to the conversion sequence in order to migrate the specified content to the selected target version.

In the depicted embodiment, the processing unit 520 includes a set of modules arranged to conduct the described functionality. The version identification module 530 identifies the source version of the specified content and provides a source version identifier 532 to the sequence determination module 540. In one embodiment, the version identification module 530 parses the content to extract metadata that explicitly identifies the source version of the specified content. In another embodiment, the source version is determined by detecting specific data patterns, structures, or attributes associated with various versions of content representation. In yet another embodiment, a user supplies the source version identifier 532 for the specified content.

The sequence determination module 540 determines a conversion sequence 542 for the combination of the source version identifier and an explicitly or implicitly specified target version. A conversion sequence 542 comprises an ordered set of converters 560. Preferably, the converters 560 are predefined. The conversion sequence 542 may include one or more converters 560 depending on the source version and target versions desired. The converters 560 are ordered such that the content is properly converted between a source version, intermediate versions, and a target version. Typically, releases of a software product introduce dependencies in the associated persistent content. Determining a proper conversion sequence 542 ensures that dependencies for the specified content expected by subsequent converters 560 are not violated as the content migrates from the source version to the target version.

In one embodiment, the sequence determination module 540 is implemented with object-oriented code as an object factory using design pattern methods. In the aforementioned embodiment, the sequence determination module 540 provides a generated object which may be a composite object to the conversion control module 550. In turn, the conversion control module 550 invokes the methods associated with the composite object. Accordingly, such an embodiment may comprise a software architecture for use in developing conversion tools for performing the migration of a source version of specified content to a target version of specified content. Using such an architecture, development efforts may be further reduced because converters 560 may be developed in a modular fashion such that the object factory can readily combine converters to produce a suitable composite object.

In one embodiment, the sequence determination module 540 uses the source and target version to conduct a table lookup operation and thereby provide the conversion sequence 542. In another embodiment, the sequence determination module 540 dynamically analyzes a directed graph such as those depicted in FIGS. 3 and 4 to determine an optimum conversion sequence 542. In yet another embodiment, the sequence determination module 540 may reference a set of migration rules. The migration rules may define which conversion sequence 542 should be used given a particular source version and target version for the specified content. In certain cases, a valid sequence may not exist and a null sequence or error code may be provided to the conversion control module 550. Typically, sufficient incremental converters 560a are provided such that at least a conversion sequence 542 of incremental converters 560a corresponding to subsequent releases is available.

The conversion control module 550 receives the conversion sequence 542 and invokes one or more content converters 560a-c corresponding to that sequence 542. In the depicted embodiment, the invoked content converters 560a-c may include incremental converters 560a, decremental converters 560b, and direct converters 560c.

The incremental converters 560a convert a particular version of content to a next version. The next version comprising a representation version compatible with a subsequent release of the associated software product. Similarly, the decremental converters 560b convert a particular version of content to a previous version. By developing an incremental converter 560a and a decremental converter 560b for each new release of a software program, each of the versions supported by a previous release may be supported by the new release through migration of the content to be compatible with the newest release. In cases where specific representations are commonly used, the direct converters 560c may be developed to improve the conversion efficiency as compared to applying successive incremental converters 560a.

The sequence determination module 540 and the conversion control module 550 operate together to accomplish a large number of conversion combinations using a small number of converters. By cascading multiple converters into a composite converter, the automated conversion system 500 reduces the development time and support cost associated with supporting a large number of versions of content representation versions.

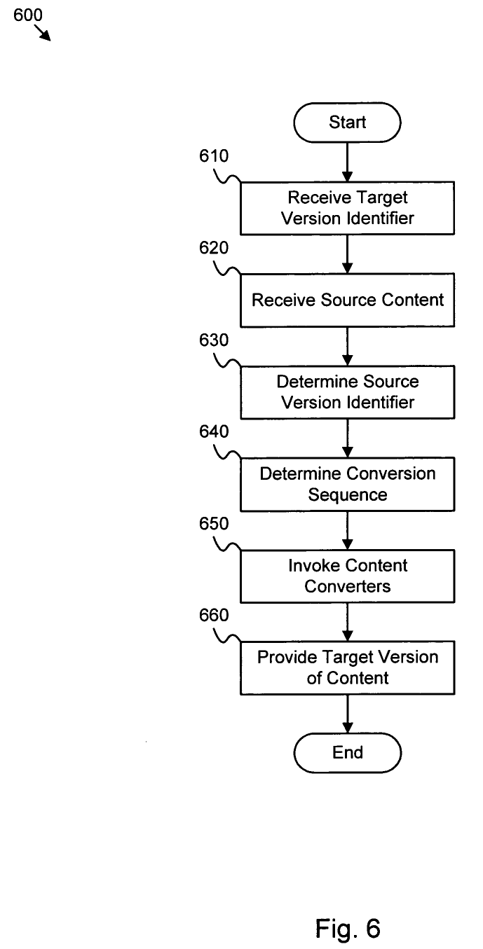

FIG. 6 is a flow chart depicting one embodiment of an automated conversion method 600. The automated conversion method 600 may be conducted in conjunction with, or independent of the automated conversion system 500. The automated conversion method 600 facilitates conducting conversions between various versions of content representation while minimizing the development and support effort associated therewith.

In the depicted embodiment, the automated conversion method 600 begins by receiving 610 a target version identifier that indicates the representation version to which the specified content is to be converted. In response to receiving 620 specific source content, the automated conversion method 600 determines 630 a source version identifier and continues by determining 640 a conversion sequence capable of converting the source content to a target version representation. In one embodiment, the conversion sequence 542 is a minimum length conversion sequence 542. The method 600 continues by invoking 650 one or more content converters corresponding to the conversion sequence 542 and providing 660 the content in the targeted version of the representation.

As mentioned previously, the various operations associated with the automated conversion method 600 may be conducted in conjunction with the automated conversion system 500 or the like. Specifically, the operation of determining 630 a source version identifier may be conducted by the version identification module 530, the operation of determining 640 a conversion sequence 542 may be conducted by the sequence determination module 540, and the operation of invoking 650 one or more content converters may be conducted by the conversion control module 550.

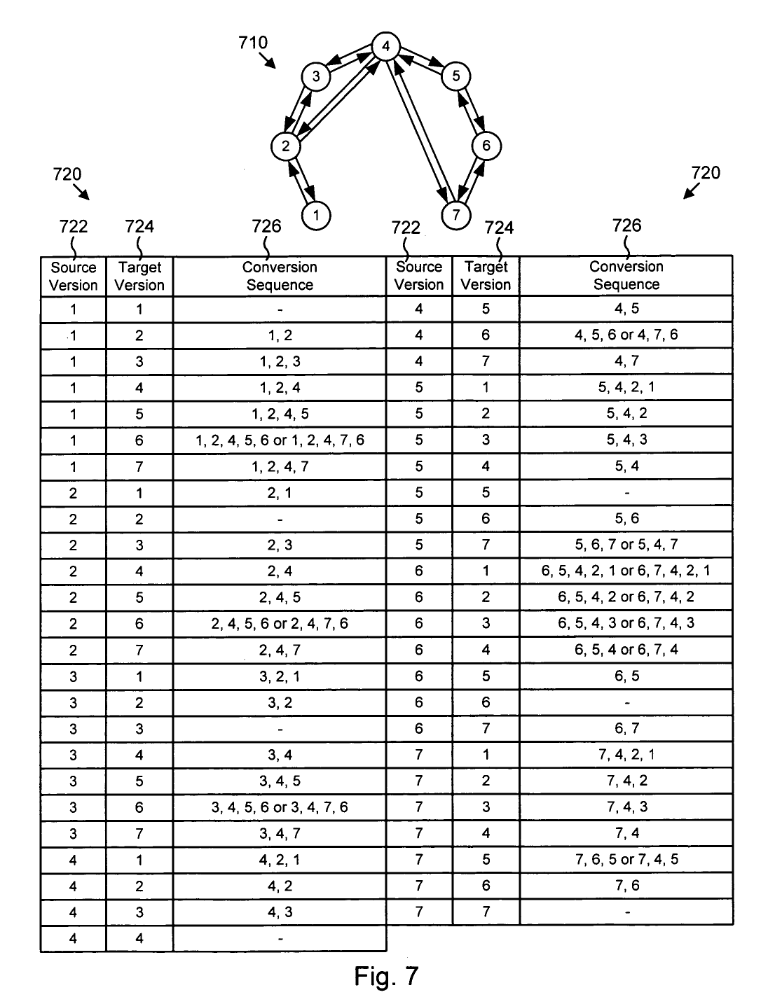

FIG. 7 depicts a directed graph 710 and corresponding lookup table 720 that collectively portray specific operations associated with the automated conversion method 600 and automated conversion system 500. In one embodiment, the lookup table 720 is extracted from the directed graph 710. In another embodiment, the lookup table 720 is generated at runtime from a list of registered converters 560. In another embodiment, the lookup table 720 is manually populated in conjunction with a release of a software program. Preferably, the lookup table 720 includes the various permutations of conversion sequences 542 such that there exists a conversion path between any two nodes 1-7 in the graph 710.

As depicted, the directed graph 710 defines the converters 560 available for conversion processing, and the lookup table 720 provides one or more minimum length processing sequences 726 for each possible combination of a source version 722 and a target version 724. With the exception of null processing sequences, each processing sequence 726 begins with a source version identifier and ends with a target version identifier and may include one or more intermediate versions. The actual number of converters that are invoked (by the conversion control module 550 or the like) to complete a conversion sequence 542 is therefore one less that the length of the listed sequence.

In the arrangement depicted in FIG. 7, seven releases of content representation versions are supported via six incremental converters, six decremental converters, and four direct converters, represented by corresponding arrows. With the sixteen aforementioned converters, 42 possible conversions (plus the 7 null conversions, conversions from a single version to itself) could be supported. Sixteen of the 42 possible conversions would involve a single converter, sixteen would involve two converters, eight would involve three converters, and two would involve four converters resulting in an average of 1.9 converters invoked for each conversion sequence 542 in table 720. In conjunction with the latest release (i.e. version 7), only one incremental converter, one decremental converter, and potentially one or more direct converters would have been developed.

The embodiments presented herein reduce the development and support burden associated with supporting conversions for a large number of versions of content representation. One of skill in the art will appreciate that the embodiments of the present invention may be embodied in other specific forms without departing from their spirit or essential characteristics. The described embodiments are to be considered in all respects only as illustrative and not restrictive. The scope of different embodiments of the invention is, therefore, indicated by the appended claims rather than by the foregoing description. All changes which come within the meaning and range of equivalency of the claims are to be embraced within their scope.

What is claimed is:

1. An apparatus for automated conversion of content having a plurality of representation versions, the apparatus comprising:
a version identification module configured to determine a source version identifier for specified content;
a sequence determination module configured to receive the source version identifier and determine a conversion sequence; and
a conversion control module configured to invoke at least one content converter corresponding to the conversion sequence.

2. The apparatus of claim 1, wherein the sequence determination module is further configured to receive a target version identifier.

3. The apparatus of claim 1, wherein the sequence determination module is further configured to select a minimum length conversion sequence.

4. The apparatus of claim 1, wherein the at least one content converter comprises a plurality of incremental converters.

5. The apparatus of claim 4, wherein the plurality of incremental converters correspond to releases of a software product.

6. The apparatus of claim 1, wherein the sequence determination module is further configured to reference a set of migration rules that designate a conversion sequence corresponding to the source version identifier.

7. The apparatus of claim 1, wherein the specified content comprises content selected from the group consisting of text, data, metadata, and code.

8. A system for automated conversion of content having a plurality of representation versions, the system comprising:
a storage device configured to store content;
a processing unit configured to execute machine-readable instructions; and
a program of machine-readable instructions executable by the processing unit, the program comprising:
an operation to determine a source version identifier for specified content,
an operation to determine a conversion sequence capable of converting the specified content to a target version, and
an operation to invoke at least one content converter corresponding to the conversion sequence.

9. The system of claim 8, wherein the program further comprises an operation to receive a target version identifier.

10. The system of claim 8, wherein the operation to determine a conversion sequence comprises selecting a minimum length conversion sequence.

11. The system of claim 8, wherein the at least one content converter comprises a plurality of incremental converters.

12. The system of claim 11, wherein the plurality of incremental converters correspond to releases of a software program.

13. The system of claim 8, wherein the at least one content converter comprises a plurality of decremental converters.

14. A signal bearing medium tangibly embodying a program of machine-readable instructions executable by a digital processing apparatus, the program comprising operations for automated conversion of content having a plurality of representation versions, the operations comprising:
an operation to determine a source version identifier for specified content;
an operation to determine a conversion sequence that orders one or more predefined content converters in order to convert the specified content to a target version; and
an operation to invoke at least one content converter corresponding to the conversion sequence.

15. The signal bearing medium of claim 14, wherein the operations further comprise an operation to receive a target version identifier.

16. The signal bearing medium of claim 14, wherein the operation to determine a conversion sequence comprises selecting a minimum length conversion sequence.

17. The signal bearing medium of claim 14, wherein the at least one content converter comprises a plurality of incremental converters.

18. The signal bearing medium of claim 17, wherein the plurality of incremental converters correspond to releases of a software product.

19. The signal bearing medium of claim 14, wherein the at least one content converter comprises a plurality of decremental converters.

20. The signal bearing medium of claim 14, wherein the specified content comprises content selected from the group consisting of text, data, metadata, and code.
